(19) United States
(12) Patent Application Publication
(10) Pub. No.: US 2009/0107212 A1
(43) Pub. Date: Apr. 30, 2009

(54) Process field instrument with integrated sensor unit and related system and method

(75) Inventor: Jeffrey M. Becker, Scottsdale, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/981,194

(22) Filed: Oct. 30, 2007

(51) Int. Cl. G01N 1/22

(52) U.S. Cl. 73/23.2

(57) ABSTRACT

A sensor is integrated with a field instrument in a process control system. For example, the sensor can be at least partially housed in a housing of the field instrument. The sensor could also receive operating power from a power source in the field instrument. The sensor could further communicate using a wired interface and/or a wireless interface of the field instrument. Multiplexing techniques could be used to allow normal communications for the field instrument and information associated with the sensor. For instance, field instrument data and sensor data could be transmitted over different interfaces or multiplexed in time for communication over a single interface. Sensor data could also be included as at least one diagnostic or configuration variable along with the field instrument data. The field instrument could represent a gas meter associated with a gas distribution network, and the sensor could represent a gas sensor.

### TECHNICAL FIELD

This disclosure relates generally to process control systems and more specifically to a process field instrument with an integrated sensor unit and related system and method.

### BACKGROUND

Many processing facilities include gas distribution networks, which are used to distribute natural gas or other hazardous gaseous materials to various portions of the facilities. It is often necessary or desirable to monitor a gas distribution network to detect unexpected gaseous emissions (such as leaks) from the distribution network. However, gas sensors are often quite expensive, both in terms of sensor hardware and in terms of the wiring for the sensors. As a result, portable gas sensors are typically used on an ad-hoc basis, and wired gas sensors are often reserved for use in critical or high-risk areas. For these and other reasons, conventional systems often fail to provide reliable and cost-effective monitoring of gas distribution networks.

Many processing facilities also include and use other types of sensors, such as vibration sensors, motion sensors, and proximity detection sensors. These types of sensors could be used for a wide variety of purposes, including security and process control. Once again, these and other types of sensors are often quite expensive, both in terms of sensor hardware and in terms of the wiring for the sensors.

### SUMMARY

This disclosure provides a process field instrument with an integrated sensor unit and related system and method.

In a first embodiment, an apparatus includes a field instrument configured to perform one or more functions in a process control system. The field instrument has a housing and is configured to communicate using at least one of a wired interface and a wireless interface. The apparatus also includes a sensor configured to detect one or more conditions. The sensor is at least partially housed in the housing and is configured to communicate using at least one of the wired interface and the wireless interface.

In particular embodiments, the sensor is a gas sensor configured to measure a concentration of one or more gaseous materials and/or to detect when a concentration of one or more gaseous materials exceeds at least one threshold.

In other particular embodiments, first data associated with the field instrument is transmitted over the wired interface, and second data associated with the sensor is transmitted over the wireless interface.

In yet other particular embodiments, first data associated with the field instrument is transmitted using a protocol, where the protocol is associated with one or more diagnostic and configuration parameters. Also, second data associated with the sensor is transmitted as at least one diagnostic or configuration variable along with the first data.

In still other particular embodiments, first data associated with the field instrument and second data associated with the sensor are multiplexed in time for communication over at least one of the wired interface and the wireless interface.

In additional particular embodiments, the sensor includes a gas sensor, a vibration sensor, a motion sensor, and/or a proximity detection sensor.

In a second embodiment, a method includes performing one or more functions in a process control system using a field instrument, where the field instrument has a housing. The method also includes detecting one or more conditions using a sensor at least partially housed in the housing of the field instrument.

In a third embodiment, a system includes a plurality of field instrument each configured to perform one or more functions in a process control system. The system also includes at least one sensor configured to detect one or more conditions and that is at least partially integrated into one of the field instruments. In addition, the system includes a controller configured to identify the one or more conditions in the process control system using information from the at least one sensor.

In a fourth embodiment, an apparatus includes at least one memory configured to store a model associated with a process control system. The apparatus also includes at least one processor configured to model movement of a gas emission in the process control system using information from at least one gas sensor. The at least one gas sensor is integrated with at least one field instrument in the process control system.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example process control system according to this disclosure;

FIG. 2 illustrates an example field instrument with an integrated sensor according to this disclosure;

FIG. 3 illustrates an example method for transmitting data from a field instrument according to this disclosure; and

FIG. 4 illustrates an example method for detecting and analyzing sensor data according to this disclosure.

### DETAILED DESCRIPTION

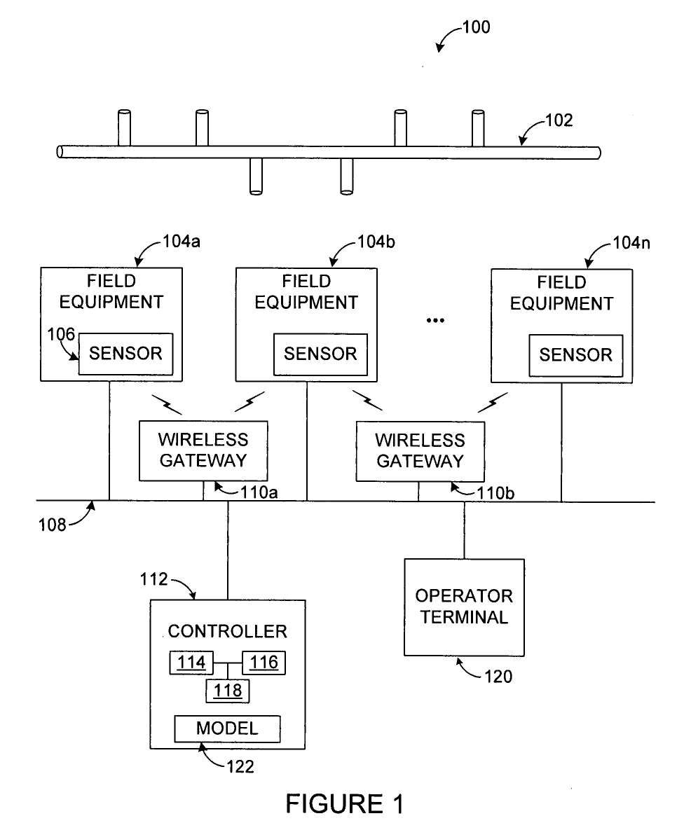

FIGS. 1 through 4, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device or system.

FIG. 1 illustrates an example process control system 100 according to this disclosure. The embodiment of the process control system 100 shown in FIG. 1 is for illustration only. Other embodiments of the process control system 100 may be used without departing from the scope of this disclosure.

As shown in FIG. 1, the process control system 100 includes a gas distribution network 102. The gas distribution network 102 typically includes a collection of pipes, valves, controllers, and other or additional structures for distributing one or more gaseous materials to one or more areas of a structure, facility, or other environment. For example, the gas distribution network 102 could be used to distribute natural gas or other fuel gas to various equipment in a processing facility or other environment. The gas distribution network 102 includes any suitable structures for distributing one or more gaseous materials.

In this example, various field instruments 104a-104n are distributed in the process control system 100. The field instruments 104a-104n represent components in the process control system 100 that can perform any of a wide variety of functions. For example, the field instruments 104a-104n could represent sensors that can measure a wide variety of process variables in the process control system 100. The process variables represent characteristics of the process control system 100, such as pressure, temperature, and flow rate in the process control system 100. The field instruments 104a-104n could also represent actuators, such as gas meters, valve actuators, or transducers, which can alter the process variables monitored by the sensors. The field instruments 104a-104n could perform any other or additional functions in the process control system 100. Each of the field instruments 104a-104n includes any suitable structure for measuring, operating on, or affecting one or more conditions in a process system.

To support the detection of gaseous emissions or other conditions in the system 100, one or more of the field instruments 104a-104n includes an integrated sensor 106. Each sensor 106 detects at least the presence of one or more gaseous materials or other conditions in the system 100. For example, in some embodiments, a sensor 106 may be capable of measuring the actual concentration of one or more gaseous materials in a specified area, such as at specified time intervals or on an ongoing or real-time basis. The actual measured concentrations and their associated times could then be output by the field instruments 104a-104n. In other embodiments, a sensor 106 may be capable of determining when the concentration of one or more gaseous materials in a specified area exceeds a threshold (without determining the actual concentration). The field instruments 104a-104n could then output signals indicating that one or more particular thresholds have been exceeded, and other information (such as the times that the thresholds were exceeded) could also be output. The sensor 106 includes any suitable structure for detecting and/or measuring one or more conditions in a process system. It may be noted that the use of an integrated gas sensor is for illustration only. Other types of sensors, such as vibration sensors, motion sensors, and proximity detection sensors, could also be integrated into the field instruments 104a-104n.

Each of the field instruments 104a-104n shown in FIG. 1 could represent a wired and/or wireless device. For example, one or more of the field instruments 104a-104n could be physically coupled to and communicate over a wired network 108. The wired network 108 can be used to transport any suitable data, such as measurements made by the sensors 106 and other field instrument data. The wired network 108 includes any suitable network or combination of networks, such as a HART, FOUNDATION FIELDBUS, Ethernet, or other network(s).

One or more of the field instruments 104a-104n could also communicate wirelessly, such as with one or more wireless gateways 110a-110b. The wireless gateways 110a-110b are coupled to the network 108 and facilitate wireless communications between those field instruments 104a-104n and the network 108. For example, the wireless gateways 110a-110b could receive wireless signals from a field instrument 104a-104n and convert the data to a protocol or format suitable for transmission over the network 108. Similarly, the wireless gateways 110a-110b could receive signals over the network 108 and convert the data to a protocol or format suitable for wireless transmission to one or more field instruments 104a-104n. Each of the wireless gateways 110a-110b includes any suitable structure for facilitating wireless communications with field instruments.

In this example, a controller 112 is also coupled to the network 108. The controller 112 is capable of controlling various components in the system 100. For example, the controller 112 could receive sensor measurement data from various field instruments 104a-104n, such as temperature, pressure, or flow rate measurements. The controller 112 could then use the measurement data to generate actuator control signals for various field instruments 104a-104n. In this way, the controller 112 is able to control the operation of equipment in the process control system 100 and to implement various control strategies in the system 100. The controller 112 includes any hardware, software, firmware, or combination thereof for analyzing and/or using sensor data, such as to control at least a portion of a process. For instance, the controller 112 could include one or more processors 114 and one or more memories 116 capable of storing instructions and data used, generated, or collected by the processor(s) 114. The controller 112 could also include at least one network interface 118 for communicating over a network, such as an Ethernet interface for communicating over the network 108.

In addition, an operator terminal 120 is coupled to the network 108. The operator terminal 120 may represent any suitable terminal, computing device, monitor, or other device suitable for monitoring or displaying data associated with the system 100. The operator terminal 120 may, for example, represent a desktop computer, laptop computer, computer terminal, portable user device, or any other or additional device.

In conventional systems, gas sensors and other types of sensors are often deployed in limited areas where there is a critical or high-risk need to be met, and portable sensors are typically used in other areas on an ad hoc basis. One of the reasons for this is that the sensors are often quite expensive. Moreover, the expense associated with installing a physical wire to a sensor being installed is often as much as or more than the cost of the sensor itself. This often limits the widespread use of certain types of sensors in a processing or other facility.

In accordance with this disclosure, a sensor 106 can be incorporated into and made a part of one or more field instruments 104a-104n. For example, a sensor 106 could be incorporated into an existing gas metering device, valve actuator, or other field instrument. If the field instrument 104a-104n is already deployed in a process control system 100, the field instrument 104a-104n can be retrofitted to include the sensors 106. The field instrument 104a-104n could also be manufactured or modified after manufacture to include the sensor 106 prior to installation.

In some embodiments, the sensors 106 can be retrofitted into existing systems, and the sensors 106 may not need to include their own power sources, casings, radios, or other infrastructure requirements (which may already exist in the installed field instruments 104a-104n). By using the existing infrastructure, it may be less expensive to incorporate the sensors 106 into the system 100. More complex levels of integration are also possible, such as when components used by the field instruments 104a-104n to perform their normal operations (like analog-to-digital converters) are also used to support functions of the sensor 106.

In this example, the controller 112 may be capable of receiving and using detection or measurement data from the sensors 106. For example, depending on the sensors 106 used, the controller 112 could receive information identifying specific concentrations of one or more gaseous materials measured by the sensors 106. The controller 112 could then determine if the measured concentrations are excessive and take suitable action. The controller 112 could also simply receive an indication that the concentration of one or more gaseous materials in a specified area has exceeded a threshold level (without receiving a particular concentration amount). Again, the controller 112 could then take suitable action. In addition, the controller 112 could receive vibration, motion, or proximity detection values from the sensors 106 and act using those values.

The controller 112 could take any suitable actions in response to receiving data from the sensors 106. For example, when used to detect an emission of one or more gaseous materials, the controller could use a model 122 and the data from multiple sensors 106 to plot the actual movement of a gas emission and to estimate how the gas emission may move in a facility of other area. The controller 112 could also notify an operator of a detected gas emission or other condition, such as by sending an alert or other message to the operation terminal 120. The controller 112 could take any other suitable actions, such as triggering an evacuation system or initiating a shutdown of the distribution network 102.

After detecting a gas emission or other condition, the controller 112 may continue to analyze data from the sensors 106. Also, an operator using the operator terminal 120 could request certain data or data reports from the controller 112. For example, the operator may request a certain gas emission report from the controller 112, which could cause the controller 112 to analyze a gas emission over time and display associated information in graphical, tabular, or other suitable form. Thus, the system 100 may continuously analyze sensor data and provide real-time information to users. The data may also be used to control operation of the equipment in the system 100.

In some embodiments, the data used, collected, or generated by the controller 112 may be stored in a memory or other persistent storage. The storage may be part of the controller 112 or located external to the controller 112. Optionally, a digital signature may be associated with the stored data for later use, such as for reporting purposes. The digital signature may be used as an authentication mechanism to, for example, certify that the data is pristine and free of any manipulation. The stored data may also be analyzed over time to produce comprehensive reports showing, for example, gas emissions or other conditions during a specified time period.

Although FIG. 1 illustrates one example of a process control system 100, various changes may be made to FIG. 1. For example, the system 100 could include any number of distribution networks, field instruments, sensors, wireless gateways, networks, controllers, and operator terminals. Also, various components in FIG. 1 could be combined or omitted and additional components could be added according to particular needs. Further, sensors 106 could be incorporated into all or a subset of the field instruments. In addition, FIG. 1 illustrates one example operational environment in which sensors can be employed in conjunction with field instruments. This functionality could be used in any other suitable device or system.

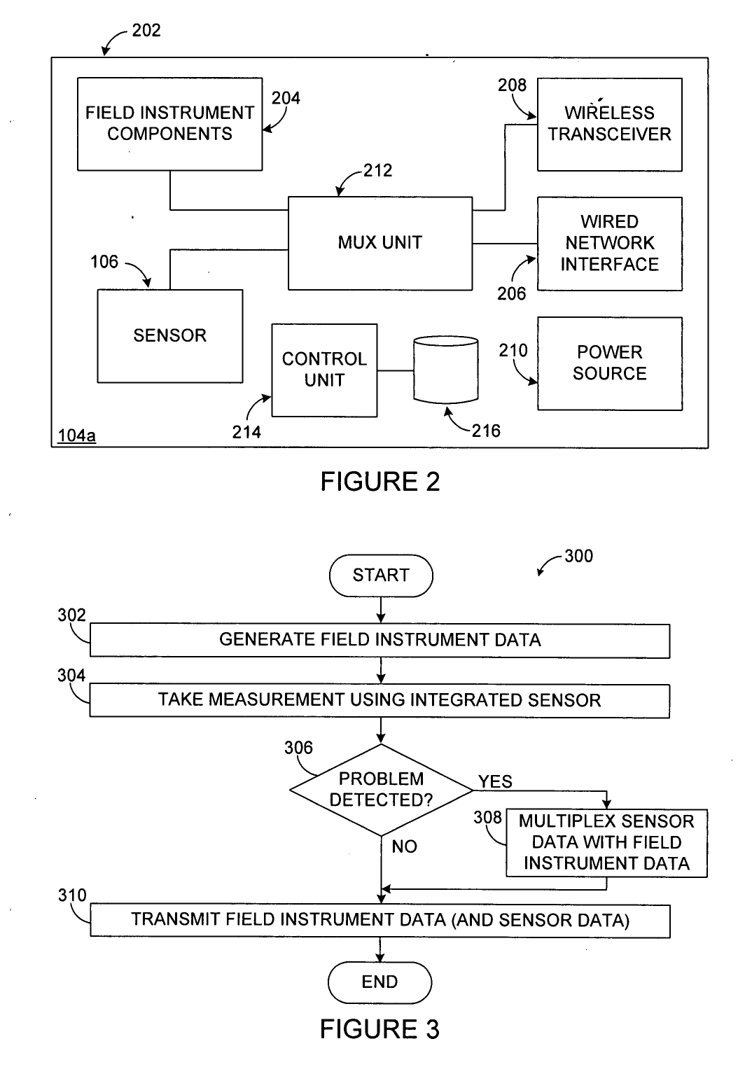

FIG. 2 illustrates an example field instrument 104a with an integrated sensor according to this disclosure. The embodiment of the field instrument 104a shown in FIG. 2 is for illustration only. Other embodiments of the field instrument 104a could be used without departing from the scope of this disclosure. Also, for ease of explanation, the field instrument 104a in FIG. 2 is described with respect to the system 100 of FIG. 1. The field instrument 104a could be used in any other suitable system.

As shown in FIG. 2, the field instrument 104a includes a housing 202. The housing 202 generally encases, retains, and protects the various components of the field instrument 104a. The housing 202 includes any suitable structure for encasing or retaining components of a field instrument, such as a metal or plastic housing.

The field instrument 104a also includes field instrument components 204. The field instrument components 204 generally represent the circuitry or other components that implement the normal function(s) of the field instrument 104a. For example, if the field instrument 104a represents a gas meter, the field instrument components 204 may include components for measuring an amount of gas flow and for displaying the measured amounts. The field instrument components 204 could include any other or additional components, depending on the normal operations or functions performed by the field instrument 104a.

A wired network interface 206 and/or a wireless transceiver 208 are also included in the field instrument 104a. The wired network interface 206 supports communication over a wired network, such as the network 108. The wired network interface 206 includes any suitable structure supporting communication over a wired network, such as a HART, FOUNDATION FIELDBUS, or Ethernet interface. The wireless transceiver 208 supports wireless communications over a wireless network, such as wireless communications with the wireless gateways 110a-110b. The wireless transceiver 208 includes any suitable structure supporting wireless communications, such as a radio frequency (RF) transceiver.

The field instrument 104a may further include a power source 210. Depending on the implementation, the power source 210 could represent an internal source of power for the field instrument 104a, such as a battery, solar cell, fuel cell, or other power source. The power source 210 could also represent a power converter, voltage regulator, or other structure(s) for receiving power from an external source and providing operating power to other components in the field instrument 104a. The power source 210 represents any suitable source of operating power for the field instrument 104a.

In some embodiments, field instruments transmit data to controllers 112 or other components on a regular basis, such as at a specified interval of time. In contrast, sensors could communicate on a less regular basis, such as only when a gas emission or other condition is detected. In any case, to facilitate use of the sensor 106 in the field instrument 104a, a multiplexing unit 212 can multiplex signals from the sensor 106 with signals from the field instrument components 204. For example, if data from the field instrument components 204 is typically transmitted over a wired network, the multiplexing unit 212 could direct data from the sensor 106 to the wireless transceiver 208 for transmission. Similarly, if data from the field instrument components 204 is typically transmitted wirelessly, the multiplexing unit 212 could direct data from the sensor 106 to the wired network interface 206 for transmission.

As another example, the protocol used to transmit data from the field instrument components 204 could include parameters with values that can be populated by the field instrument 104a. For instance, the protocol used to transmit data from the field instrument components 204 could also include one or more configurable parameters, such as parameters for carrying diagnostic information. The multiplexing unit 212 could use one or more of the configurable parameters to transmit data from the sensor 106. As a third example, the multiplexing unit 212 could multiplex data from the field instrument components 204 and the data from the sensor 106 in time for communication wirelessly or via a wired connection. Any other or additional technique(s) could be used by the multiplexing unit 212 to transmit data from the field instrument components 204 and the sensor 106. The multiplexing unit 212 includes any suitable structure for transmitting data from multiple sources.

In this example, the field instrument 104a also includes a control unit 214 and a memory 216. The control unit 214 generally controls the overall operation of the field instrument 104a. For example, the control unit 214 could control the multiplexing of data by the multiplexing unit 212. The control unit 214 could also control the collection of measurements or detection readings taken by the sensor 106 and control the operation of the field instrument components 204. The control unit 214 includes any suitable structure for controlling one or more aspects of the field instrument 104a, such as a microprocessor, microcontroller, application specific integrated circuit (ASIC), or other structure. The memory 216 can be used to store any suitable data, such as instructions used by the control unit 214 and sensor data generated by the sensor 106. The memory 216 includes any suitable storage and retrieval device or devices, such as a random access memory or a read-only memory.

As noted above, a sensor 106 can be retrofitted or incorporated into the field instrument 104a. In this example, the sensor 106 can be at least partially housed in the same housing 202 as the field instrument components 204, and data from the sensor 106 could be transmitted using the same wired network interface 206 or wireless transceiver 208 in the field instrument 104a. Also, the sensor 106 could receive operating power from the same power source 210. All of this may help to reduce the expense of the sensor 106. Moreover, as noted above, the sensor 106 could rely on or include some of the field instruments components 204 (such as analog-to-digital converters or other elements), which may further reduce the expense of the sensor 106. Further, because the sensor 106 may use the same process control network (such as a wired or wireless network) used by the field instrument components 204, the cost of physically wiring the sensor 106 is reduced or eliminated. In addition, simpler sensors (such as sensors 106 that detect when gas concentrations exceed a threshold without measuring the exact concentrations) can be used, which may even further reduce the expense of the sensor 106. Of course, a sensor 106 that can measure exact gas concentrations can also be used. In these ways, the reduced expense and easier installation of the sensors 106 may allow more sensors 106 to be deployed in the system 100. This may allow more complex control in the system 100, such as by allowing the actual path of a gas emission to be predicted or tracked.

Although FIG. 2 illustrates one example of a field instrument 104a with an integrated sensor, various changes may be made to FIG. 2. For example, the functional division shown in FIG. 2 is for illustration only. Various components in FIG. 2 could be combined or omitted and additional components could be added according to particular needs. As a particular example, the multiplexing unit 212 could be incorporated into the control unit 214.

FIG. 3 illustrates an example method 300 for transmitting data from a field instrument according to this disclosure. The embodiment of the method 300 shown in FIG. 3 is for illustration only. Other embodiments of the method 300 could be used without departing from the scope of this disclosure. Also, for ease of explanation, the method 300 in FIG. 3 is described with respect to the field instrument 104a of FIG. 2 operating in the system 100 of FIG. 1. The method 300 could be used by any suitable device and in any suitable system.

Field instrument data is generated by the field instrument 104a at step 302. This may include, for example, the field instrument components 204 generating data during the normal operations of the field instrument 104a. As a particular example, this could include the field instrument components 204 in a gas meter generating gas measurement values.

Measurements are taken using an integrated sensor are taken at step 304. This may include, for example, the sensor 106 in the field instrument 104a measuring the concentration of one or more gaseous materials. This may also include the sensor 106 in the field instrument 104a determining if the concentration of one or more gaseous materials exceeds at least one threshold. Any other or additional measurements could be taken using the sensor 106.

The field instrument 104a determines if a problem has been detected at step 306. This may include, for example, the control unit 214 determining if the measured gas concentration from the sensor 106 exceeds at least one threshold. This may also include the control unit 214 determining if the sensor 106 has signaled that at least one threshold has been exceeded.

If so, sensor data is multiplexed with field instrument data at step 308. In either case, the field instrument data (possibly along with the sensor data) is transmitted at step 310. This may include, for example, the multiplexing unit 212 sending sensor data and field instrument data to different ones of the wired network interface 206 and the wireless transceiver 208. This may also include the multiplexing unit 212 inserting the sensor data as diagnostic or configuration values in messages used to transport the field instrument data. This may further include the multiplexing unit 212 multiplexing the sensor data and the field instrument data in time over the same communication link. The sensor data transmitted during these steps could represent any suitable data, such as actual gas concentrations or indications that thresholds have been exceeded.

Although FIG. 3 illustrates one example of a method 300 for transmitting data from a field instrument, various changes may be made to FIG. 3. For example, while shown as a series of steps, various steps in FIG. 3 could overlap, occur in a different order, or occur multiple times.

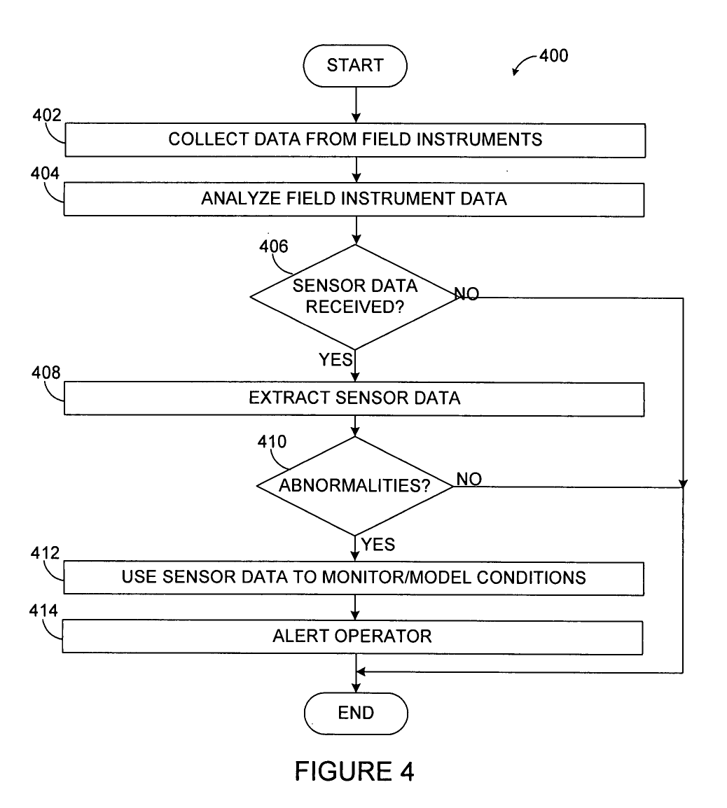

FIG. 4 illustrates an example method 400 for detecting and analyzing sensor data according to this disclosure. The embodiment of the method 400 shown in FIG. 4 is for illustration only. Other embodiments of the method 400 could be used without departing from the scope of this disclosure. Also, for ease of explanation, the method 400 in FIG. 4 is described with respect to the controller 112 operating in the system 100 of FIG. 1. The method 400 could be used by any suitable device and in any suitable system.

Data from field instruments is collected at step 402. This could include, for example, the controller 112 collecting data from the field instruments 104a-104n over the network 108. The data could be contained in messages, and data from the appropriate fields can be extracted from the messages.

Field instrument data from the field instruments is analyzed at step 404. This may include, for example, the controller 112 extracting field instrument data related to the operation of gas metering devices, valve actuators, or other field instruments. The controller 112 could then use the field instrument data in any suitable manner.

A determination is made as to whether sensor data has also been received at step 406. This may include, for example, determining if sensor data has been received in a separate transmission, as part of the field instrument data, or multiplexed in time with the field instrument data. If not, the method 400 may end.

Otherwise, the sensor data is extracted and analyzed at step 408. This may include, for example, the controller 112 extracting the sensor data from messages received over the network 108, where the message may or may not include the field instrument data. At this point, a determination is made as to whether any abnormal conditions exist at step 410. This may include, for example, the controller 112 determining if any gas measurements exceed specified thresholds. If not, no further action is necessary, and the method 400 ends.

If one or more abnormalities are detected, a gas emission or other condition may have been detected, and the system 100 may take any suitable action. For example, conditions in the process control system can be monitored or modeled at step 412. This could include, for example, the controller 112 using data from multiple sensors 106 to monitor the actual movement of a gas emission. This may also include the controller 112 using the model 122 to predict future movement of the gas emission. Also, an operator is alerted at step 414. This may include, for example, presenting a pertinent message or alert to an operator terminal 120. Any other actions could also occur, such as providing a shut-down message or lock-down order to certain equipment in a processing facility or other environment.

Although FIG. 4 illustrates one example of a method 400 for detecting and analyzing sensor data, various changes may be made to FIG. 4. For example, while shown as a series of steps, various steps in FIG. 4 could overlap, occur in a different order, or occur multiple times.

In some embodiments, various functions described above are implemented or supported by a computer program that is formed from a computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases used throughout this patent document. The term “couple” and its derivatives refer to any direct or indirect communication between two or more elements, whether or not those elements are in physical contact with one another. The terms “application” and “program” refer to one or more computer programs, software components, sets of instructions, procedures, functions, objects, classes, instances, related data, or a portion thereof adapted for implementation in a suitable computer code (including source code, object code, or executable code). The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The term “controller” means any device, system, or part thereof that controls at least one operation. A controller may be implemented in hardware, firmware, software, or some combination of at least two of the same. The functionality associated with any particular controller may be centralized or distributed, whether locally or remotely.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An apparatus comprising:
a field instrument configured to perform one or more functions in a process control system, the field instrument having a housing and configured to communicate using at least one of a wired interface and a wireless interface; and
a sensor configured to detect one or more conditions, the sensor at least partially housed in the housing and configured to communicate using at least one of the wired interface and the wireless interface.

2. The apparatus of claim 1, wherein the sensor comprises a gas sensor configured to measure a concentration of one or more gaseous materials.

3. The apparatus of claim 1, wherein the sensor comprises a gas sensor configured to detect when a concentration of one or more gaseous materials exceeds at least one threshold.

4. The apparatus of claim 1, wherein:
first data associated with the field instrument is transmitted over the wired interface; and
second data associated with the sensor is transmitted over the wireless interface.

5. The apparatus of claim 1, wherein:
first data associated with the field instrument is transmitted using a protocol, the protocol associated with one or more diagnostic and configuration parameters; and
second data associated with the sensor is transmitted as at least one diagnostic or configuration variable along with the first data.

6. The apparatus of claim 1, wherein first data associated with the field instrument and second data associated with the sensor are multiplexed in time for communication over at least one of the wired interface and the wireless interface.

7. The apparatus of claim 1, further comprising:
a single power source configured to provide power to the field instrument and to the sensor.

8. The apparatus of claim 1, wherein:
the wired interface comprises an Ethernet interface; and
the wireless interface comprises a radio frequency transceiver.

9. The apparatus of claim 1, further comprising:
a memory configured to store information associated with operation of the sensor.

10. The apparatus of claim 1, wherein the sensor comprises at least one of: a gas sensor, a vibration sensor, a motion sensor, and a proximity detection sensor.

11. A method comprising:
performing one or more functions in a process control system using a field instrument, the field instrument having a housing; and
detecting one or more conditions using a sensor at least partially housed in the housing of the field instrument.

12. The method of claim 11, wherein detecting the one or more conditions comprises measuring a concentration of one or more gaseous materials.

13. The method of claim 11, wherein detecting the one or more conditions comprises detecting when a concentration of one or more gaseous materials exceeds at least one threshold.

14. The method of claim 11, further comprising:
communicating first data associated with the field instrument over a wired interface; and
communicating second data associated with the sensor over a wireless interface.

15. The method of claim 11, further comprising:
communicating first data associated with the field instrument using a protocol, the protocol associated with one or more diagnostic and configuration parameters; and
communicating second data associated with the sensor as at least one diagnostic or configuration variable along with the first data.

16. The method of claim 11, further comprising multiplexing first data associated with the field instrument and second data associated with the sensor in time for communication over at least one of a wired interface and a wireless interface.

17. The method of claim 11, further comprising:
providing power from a single power source to the field instrument and to the sensor.

18. The method of claim 11, further comprising:
retrofitting the field instrument to include the sensor.

19. The method of claim 11, wherein performing the one or more functions using the field instrument comprises metering one or more gaseous materials in a gas distribution network using a gas meter.

20. A system comprising:
a plurality of field instrument each configured to perform one or more functions in a process control system;
at least one sensor configured to detect one or more conditions and at least partially integrated into one of the field instruments; and
a controller configured to identify the one or more conditions in the process control system using information from the at least one sensor.

21. The system of claim 20, wherein:
the at least one sensor comprises at least one gas sensor; and
the controller is configured to model movement of a gas emission in the process control system using the information from the at least one gas sensor.

22. An apparatus comprising:
at least one memory configured to store a model associated with a process control system; and
at least one processor configured to model movement of a gas emission in the process control system using information from at least one gas sensor, the at least one gas sensor integrated with at least one field instrument in the process control system.

23. The apparatus of claim 22, wherein the at least one field instrument comprises a gas meter associated with a gas distribution network.
